(19) United States
(12) Patent Application Publication
(10) Pub. No.: US 2022/0177705 A1
(43) Pub. Date: Jun. 9, 2022

(54) Modification Of Asphalt Formulations Containing Recycled Materials With Polymers Derived From Depolymerized Plastics

(71) Applicant: GreenMantra Recycling Technologies Ltd., Brantford (CA)

(72) Inventors: John Almey, Burlington (CA); Domenic Di Mondo, Brampton (CA)

(21) Appl. No.: 17/681,788

(22) Filed: Feb. 27, 2022

Related U.S. Application Data
(63) Continuation of application No. PCT/CA2020/051166, filed on Aug. 27, 2020.
(60) Provisional application No. 62/892,129, filed on Aug. 27, 2019.

(51) Int. Cl. C08L 95/00; C08L 91/06

(52) U.S. Cl. CPC C08L 95/00; C08L 2207/24; C08L 2555/34; C08L 91/06

(57) ABSTRACT

Asphalt formulations containing ground tire rubber and/or plastics can be modified by polymers, oligomers, and waxes made from polymeric material. The addition of polymer, oligomer, or wax can improve stability of ground tire rubber and/or plastic in the asphalt leading to lower formulation costs for polymer modified asphalt producers. In addition, these stable formulations can reduce risk of rutting, and cracking in asphalt roads. The polymer, oligomer, or wax can be made by catalytic depolymerization and/or thermal degradation of polymeric material. The polymeric material can be polystyrene, polypropylene, polyethylene, a combination of polypropylene and polyethylene or recycled plastics.

### CROSS-REFERENCE TO RELATED APPLICATION

This application is a continuation of and claims priority benefits from International Application No. PCT/CA2020/051166 filed on Aug. 27, 2020, entitled “Modification of Asphalt Formulations Containing Recycled Materials with Polymers Derived from Depolymerized Plastics”. The '166 application, and the present application, claim priority to U.S. provisional patent application Ser. No. 62/892,129 filed on Aug. 27, 2019, also entitled, “Modification of Asphalt Formulations Containing Recycled Materials with Polymers Derived from Depolymerized Plastics”. The '166 and '129 applications are hereby incorporated by reference herein in their entireties.

### FIELD OF THE INVENTION

The present invention relates to a method of employing polymers, oligomers, and waxes, from now on just referred to as waxes, as additives in asphalt formulations containing recycled materials such as ground tire rubber “GTR” (also referred to as crumb rubber modifier), and recycled plastics including but not limited to polyolefin, polystyrene, polyethylene, terephthalate, and/or multi-layer plastics.

In some embodiments, the waxes are created via the depolymerization of polymers. In some embodiments, the addition of the wax(es) to asphalts containing plastics or ground tire rubber improves properties including, but not limited to, reducing the separation of the recycled materials from the asphalt binder, elastic performance, rutting, and/or low temperature cracking.

It is often advantageous for asphalt to resist flow at high temperatures and/or penetration from physical forces. Various applications require relatively stable asphalt at high temperatures. For example, paving asphalt should be able to withstand high temperatures encountered in different climates. This ability to withstand high temperatures is conferred by the asphalt's resistance to flow at high temperatures measured by the softening point of the material (the temperature at which the asphalt achieves a specified degree of viscosity). In at least some embodiments, asphalts with high softening points are better suited for avoiding damage at higher temperatures.

In addition to resistance to flow, the hardness of an asphalt can be modified for particular applications. A penetration test serves as one metric to measure the hardness of asphalt. Paving asphalt is often made harder to reduce penetration from heavy forces, such as large trucks. Harder asphalts that are stable at high and low temperatures are also less likely to rut and/or crack.

The use of rubbers and polyolefin plastics in asphalt formulations tends to provide a better performing road with increased resilience to traffic and loads. Typical rubbers include fossil and/or virgin styrene-butadiene-styrene (SBS) rubbers and/or recycled ground tire rubber. GTR tends to be more cost effective. Typical recycled materials can include, but are not limited to, high-density polyethylene (HDPE), low-density polyethylene (LDPE), low linear-density polyethylene (LLDPE), and polypropylene (PP) or a combination thereof. Additionally, the use of GTR and recycled polyolefin plastics has a positive environmental impact as it recycles waste tires and plastics that would otherwise end up in landfills. However, GTR is often not used due to its cross-linked nature which can increase asphalt viscosity and make the asphalt more difficult to process. In addition, the stability of GTR and plastics in asphalt can be poor, leading to separation or settling of the rubber or plastics at working and/or storage temperatures. This makes preparation and storage an issue. It also reduces the effectiveness of the final product and can cause a decrease in the lifespan of a road. However, when GTR and/or plastics are incorporated properly, they can increase the performance of the road, including rut resistance and, specific to GTR, noise reduction.

Waxes can be employed to modify asphalt. Various processes are disclosed in International Application PCT/CA2017/050172 entitled “Polymer-Modified Asphalt with Wax Additive” and International Application PCT/CA2019/050762 entitled “Modification of Asphalt Oxidation and Binders with Polymers” which are hereby incorporated by reference. Waxes are compatible with a wide variety of asphalt additives and can be combined with a variety of materials commonly employed to improve the quality of asphalts.

In some embodiments, such waxes can be generated from plastic feedstocks including solid waste. A process to form synthetic waxes from solid waste is discussed in U.S. Pat. No. 8,664,458 “Kumar”. U.S. Pat. No. 8,664,458 is hereby incorporated by reference.

A method of employing waxes produced from thermal degradation and/or catalytic depolymerization of plastic feedstocks to improve the physical properties of asphalt formulations including reducing the separation of the ground tire rubber and recycled plastics, including but not limited to polyolefin, polystyrene, polyethylene, terephthalate, and/or multi-layer plastics, from the asphalt binder, which can then lead to improvement in performance related to elastic performance, performance grade bumping, rutting, and low temperature cracking, would be commercially advantageous, environmentally responsible and a public health benefit. In some embodiments, these waxes can help adjust the resistance to flow and hardness of the asphalt independent of oxidation. In at least some embodiments, the use of these waxes can reduce, if not eliminate, the need for oxidization.

### SUMMARY OF THE INVENTION

An asphalt formulation can include an amount of a wax, an amount of a ground tire rubber and/or an amount of recycled plastic, and an amount of a base asphalt.

In some embodiments, the asphalt formulation can include an amount of an asphalt extender, an amount of an asphalt flux, and/or an amount of a cross linking agent.

In some embodiments, the wax is made via depolymerization of a polymeric material. In some embodiments, the polymeric material is made up of polystyrene, polyethylene, and/or polypropylene. In some embodiments, the polymeric material is at least partially made up of recycled plastics including, but not limited to, polyolefin, polystyrene, polypropylene, polyethylene, terephthalate, and/or multi-layer plastics.

In some embodiments, the depolymerization of a polymeric material is a catalytic process, a thermal process, utilizes free radical initiators, and/or utilizes radiation.

In some embodiments, the amount of wax is between and inclusive of 0.5 to 20 percent by weight of the asphalt formulation.

In some embodiments, the amount of ground tire rubber is between and inclusive of 1 to 30 percent by weight of the asphalt formulation.

In some embodiments, the amount of recycled plastics is between and inclusive of 1 to 75 percent by weight of the asphalt formulation.

In some embodiments, the amount of base asphalt is between and inclusive of 50 to 98.5 percent by weight of the asphalt formulation.

In some embodiments, the wax has a melting point between and inclusive of 100-170° C., a viscosity between and inclusive of 20-10,000 cps and/or an acid number between inclusive of 0-50 mg KOH/g.

A method of manufacturing an asphalt formulation can include mixing an amount of a wax, an amount of a ground tire rubber and/or an amount of recycled plastic, and an amount of a base asphalt.

### DETAILED DESCRIPTION OF ILLUSTRATIVE EMBODIMENT(S)

Various waxes generated from plastic feedstocks can be used to modify asphalt formulations containing GTR and/or recycled plastics, including but not limited to polyolefin, polystyrene, polypropylene, polyethylene, terephthalate, and/or multi-layer plastics. In some embodiments, the wax is made by catalytic depolymerization of polymeric material. In some embodiments, the wax is made by depolymerizing and/or thermally degrading polymeric material. In some embodiments, the catalyst used is a zeolite or alumina supported system or a combination of the two. In some embodiments, the catalyst is [Fe—Cu—Mo—P]/Al₂O₃.

In some embodiments, the catalyst is prepared by binding a ferrous-copper complex to an alumina or zeolite support and reacting it with an acid comprising metals and non-metals to obtain the catalyst material. In some embodiments, the catalyst comprises Al, Fe, Cu, and O, prepared by binding ferrous and copper complexes to an alumina and/or zeolite support. Other suitable catalyst materials include, but are not limited to, zeolite, mesoporous silica, H-mordenite and alumina.

In some embodiments, the wax is made by catalytically depolymerizing and/or thermally degrading polymeric material. In some embodiments, depolymerization can occur through the action of free radical initiators or the exposure to radiation.

In some embodiments, the polymeric material is polyethylene. In some embodiments, the polymeric material is polypropylene. In some embodiments, the polymeric material is polystyrene. The polymeric material can be polypropylene (PP), polystyrene (PS), high-density polyethylene (HDPE), low-density polyethylene (LDPE), linear low-density polyethylene (LLDPE), and/or other variations of polyethylene.

In other embodiments, the polymeric material includes both polyethylene and polypropylene material. In some embodiments, the polymeric material is divided evenly by weight between polyethylene and polypropylene. In some embodiments, the polymeric material can contain up to 20% PP, lower levels of polystyrene, polyethylene terephthalate (PET), ethylene-vinyl acetate (EVA), polyvinyl chloride (PVC), ethylene vinyl alcohol (EVOH), and undesirable additives and/or contaminants, such as fillers, dyes, metals, various organic and inorganic additives, moisture, food waste, dirt, and/or other contaminating particles.

In other embodiments, the polymeric material includes combinations of LDPE, LLDPE, HDPE, and PP.

In some embodiments, the polymeric material comprises recycled plastics including, but not limited to, polyolefin, polystyrene, polyethylene, terephthalate, and/or multi-layer plastics. In other or the same embodiments, the polymeric material comprises recycled plastics and/or virgin plastics.

In some embodiments, the polymeric material includes waste polymeric material feed. Suitable waste polymeric material feeds include mixed polystyrene waste, mixed polyethylene waste, mixed polypropylene waste, and/or a mixture including mixed polyethylene waste and mixed polypropylene waste. In some embodiments, the mixed polyethylene waste can include LDPE, LLDPE, HDPE, PP, or a mixture including combinations of LDPE, LLDPE, HDPE, and/or PP. In some embodiments, the mixed polyethylene waste can include film bags, milk jugs or pouches, totes, pails, caps, agricultural film, and/or packaging material. In some embodiments, the mixed polypropylene waste can include carpet fibers, bottle caps, yogurt containers, and/or bottle labels. In some embodiments, the mixed polystyrene waste can include food packaging containers, insulation, and/or electronic packaging. In some embodiments, the waste polymeric material feed includes up to 10% by weight of material other than polymeric material, based on the total weight of the waste polymeric material feed.

In some embodiments, the polymeric material is one of, or a combination of, virgin polyethylene (any one of, or combinations of, HDPE, LDPE, LLDPE and medium-density polyethylene (MDPE)), virgin polypropylene, or post-consumer, or post-industrial, polyethylene and/or polypropylene (exemplary sources including bags, jugs, bottles, pails, and/or other items containing PE and/or PP).

In some embodiments, the addition of the wax changes the physical characteristics of the asphalt formulations including, but not limited to:
increasing the softening point of asphalt;
decreasing the penetration of the asphalt;
reducing the time required for asphalt oxidation;
lowering the formulation viscosity;
increasing the stiffness of the asphalt; and/or
allowing higher levels of GTR and/or plastics to added without phase separation.

In some embodiments, the percentage of wax in the asphalt formulation can be between and inclusive of 0.5 to 20 percent by weight. In some preferred embodiments, the percentage of wax in the asphalt formulation can be between and inclusive of 1 to 5 percent by weight. In some more preferred embodiments, the percentage of wax in the asphalt formulation can be between and inclusive of 1 to 3 percent by weight.

In some embodiments, the percentage of GTR in the asphalt formulation can be between and inclusive of 1 to 30 percent by weight. In some preferred embodiments, the percentage of GTR in the asphalt formulation can be between and inclusive of 5 to 25 percent by weight. In some more preferred embodiments, the amount of GTR in the asphalt formulation can be between and inclusive of 10 to 20 percent by weight.

In some embodiments, the GTR can be generated from various methods, including mechanical, cryogenic, and/or other devulcanization methods.

In some embodiments, the percentage of recycled plastics in the asphalt formulation can be between and inclusive of 1 to 75 percent by weight. In some preferred embodiments, the amount of plastic in the asphalt formulation can be between and inclusive of 1 to 35 percent by weight.

In some embodiments, the asphalt formulation can include base asphalt, asphalt extender, asphalt flux, ground tire rubber, styrene-butadiene-styrene (SBS), cross linking agent, fillers, atactic polypropylene (APP), polypropylene, and polyethylene, styrene-ethylene-butylene-styrene (SEBS), ethylene-vinyl acetate (EVA), polyphosphoric acid (PPA), and/or ethylene acrylate copolymers.

In some embodiments, the amount of asphalt is between and inclusive of 50 to 98.5 percent by weight.

In at least some embodiments, the wax is incorporated into paving asphalts. In some embodiments, waxes can be used to modify paving asphalt binders.

In some embodiments the waxes can have melting points between and inclusive of 100-170° C., viscosities between and inclusive of 20-10,000 cps, and/or acid numbers between and inclusive of 0-50 mg KOH/g. In some preferred embodiments, the wax(es) employed have melting points between and inclusive of 110-170° C., viscosities between and inclusive of 20-5000 cps, and/or acid numbers between and inclusive of 0-34 mg KOH/g. In some more preferred embodiments, the wax(es) employed have melting points between and inclusive of 112-166° C., viscosities between and inclusive of 37.5-3000 cps, and/or acid numbers between and inclusive of 0-22 mg KOH/g.

Changes in melting point, viscosity, molecular weight, and/or polymer backbone structure of the wax can change the properties of the asphalt mixture. In general, addition of waxes will increase the softening point of the asphalt due to the polymers having higher softening points than the asphalt mixture. In general, addition of waxes will lower viscosities at formulating temperatures.

In some embodiments, use of waxes with GTR can produce a stable rubberized asphalt binder, or asphalt rubber binder. In some embodiments, the asphalt, GTR, and wax are mixed together. Various methods can be used to add the waxes to the asphalt including, but not limited to, wet, terminal blending, and dry methods. Wet methods involve heating the asphalt and mixing in the wax prior to the addition of aggregate in the asphalt. Dry mixing methods involve adding the wax at the same time as the aggregate. In terminal blending methods, the asphalt and tire rubber are mixed at a terminal and either transported or stored for later transportation to the job site. In some embodiments, the wax is added before the rubber/plastics. In some embodiments, the wax is added at the same time as the rubber/plastics. In some embodiments, the wax is added after the rubber/plastics.

In some embodiments, use of waxes with plastics can produce a stable polymer modified asphalt binder. In some embodiments, the asphalt, plastic, and wax are mixed together. Various methods can be used to add the waxes to the asphalt including, but not limited to, wet, terminal blending, and dry methods. Wet methods can involve heating the asphalt and mixing in the wax prior to the addition of aggregate in the asphalt. Dry mixing methods can involve adding the wax at the same time as the aggregate. In terminal blending methods, the asphalt and plastics are mixed at a terminal and either transported or stored for later transportation to the job site.

In some embodiments, high shear is used during the mixing. In some embodiments, the mixing is conducted at temperatures between and inclusive of 160° C. and 220° C. In some preferred embodiments, the mixing is conducted at temperatures between and inclusive of 180° C. to 200° C. In some embodiments, the mixing is conducted between and inclusive of 30 minutes to 6 hours. In some preferred embodiments, the mixing is conducted between and inclusive of 1 hour to 2 hours. In some embodiments, the mixing is conducted between and inclusive of 1000 to 10000 rpm. In some preferred embodiments, the mixing is conducted between and inclusive of 1000 to 4000 rpm. In at least some embodiments, the resulting mixture can be stored to be used in roads with minimal separation compared to the same formula without the wax additive.

### Example 1: Addition of Various Waxes to Asphalt Formulations

In a first example, effects of the addition of various waxes formed via depolymerization of various polymers to asphalt formulations containing GTR were observed. As set forth in Tables 1-3, unmodified paving grade asphalt served as a control.

TABLE 1
Sample Data Components

| Ingredient | Grade/Type | Source |
|---|---|---|
| Asphalt | Paving Grade Asphalt | Commercial Stock |
| | (PG64-22) | |
| Ground Tire Rubber | 40 Mesh | Commercial Stock |
| Polyethylene Wax | A115 wax | GreenMantra (Applicant) |
| Polyethylene Wax | A120 wax | GreenMantra (Applicant) |
| Polyethylene Wax | A125 wax | GreenMantra (Applicant) |
| Polypropylene Wax | A155 wax | GreenMantra (Applicant) |
| Polypropylene wax | A163 wax | GreenMantra (Applicant) |

TABLE 2
Asphalt Components as Percentage of Total Weight

| | Formulation | | | | | | | | | |
|---|---|---|---|---|---|---|---|---|---|---|
| | Control | A | B | c | D | E | F | G | H | I |
| PG64-22 | 100 | 90 | 88 | 87 | 88 | 87 | 88 | 87 | 88 | 87 |
| Ground Tire Rubber | 0 | 10 | 10 | 10 | 10 | 10 | 10 | 10 | 10 | 10 |
| A120 wax | 0 | 0 | 2 | 3 | 0 | 0 | 0 | 0 | 0 | 0 |
| A125 wax | 0 | 0 | 0 | 0 | 2 | 3 | 0 | 0 | 0 | 0 |
| A155 wax | 0 | 0 | 0 | 0 | 0 | 0 | 2 | 3 | 0 | 0 |
| A163 wax | 0 | 0 | 0 | 0 | 0 | 0 | 0 | 0 | 2 | 3 |

TABLE 3
Asphalt Properties

| | Formulation | | | | | | | | | |
|---|---|---|---|---|---|---|---|---|---|---|
| | Control | A | B | C | D | E | F | G | H | I |
| Penetration at 25° C. | 61.7 | 47.7 | 46 | 46 | 44 | 40 | 41 | 38 | 43 | 39 |
| (dmm) | | | | | | | | | | |
| Softening point | 51.8 | 58.2 | 61.8 | 63.1 | 64.6 | 68.2 | 64 | 70.7 | 62.3 | 64.7 |
| Viscosity at 190° C., | 75.6 | 267.6 | 307.8 | 343.8 | 440 | 387 | 312.6 | 295.2 | 271.8 | 360.6 |
| s34 | | | | | | | | | | |
| (cPs) | | | | | | | | | | |
| Separation | 52.5 | 56.9 | 56.9 | 58.8 | 60.0 | 64.5 | 81.9 | 115.6 | 80.8 | 95.5 |
| Softening Point | | | | | | | | | | |
| (Top) | | | | | | | | | | |
| (° C.) | | | | | | | | | | |
| Separation | 52.4 | 76.3 | 73.7 | 74.6 | 71.7 | 77.6 | 83.7 | 113.3 | 88.8 | 99.8 |
| Softening Point | | | | | | | | | | |
| (Bottom) | | | | | | | | | | |
| (° C.) | | | | | | | | | | |
| Separation | −0.1 | 19.4 | 16.8 | 15.8 | 11.7 | 13.1 | 1.8 | −2.3 | 8.0 | 4.3 |
| difference | | | | | | | | | | |
| (° C.) | | | | | | | | | | |

In the present example, asphalt blends were prepared using a wet method by mixing GTR and, in some blends, a wax into paving grade asphalt using a Silverson L5M-A high-shear mixer for one hour at 180° C.

As set forth in Table 2, Control Formulation consisted of 100% by weight of PG64-22.

Wax Blend Formulation A consisted of 90% by weight PG64-22 and 10% by weight of Ground Tire Rubber.

Wax Blend Formulation B consisted of 88% by weight PG64-22, 10% by weight of Ground Tire Rubber, and 2% by weight of A120.

Wax Blend Formulation C consisted of 87% by weight PG64-22, 10% by weight of Ground Tire Rubber, and 3% by weight of A120.

Wax Blend Formulation D consisted of 88% by weight PG64-22, 10% by weight of Ground Tire Rubber, and 2% by weight of A125.

Wax Blend Formulation E consisted of 87% by weight PG64-22, 10% by weight of Ground Tire Rubber, and 3% by weight of A125.

Wax Blend Formulation F consisted of 88% by weight PG64-22, 10% by weight of Ground Tire Rubber, and 2% by weight of A155.

Wax Blend Formulation G consisted of 87% by weight PG64-22, 10% by weight of Ground Tire Rubber, and 3% by weight of A155.

Wax Blend Formulation H consisted of 88% by weight PG64-22, 10% by weight of Ground Tire Rubber, and 2% by weight of A163.

Wax Blend Formulation I consisted of 87% by weight PG64-22, 10% by weight of Ground Tire Rubber, and 3% by weight of A163.

The softening point of the formulations were determined using ASTM D3461, the penetration of the formulations was determined using ASTM Method D5, the viscosity of the formulations was determined using ASTM Method D4402, and the separation tendency of the polymer from the asphalt was determined using ASTM D7173.

The following conclusions can be drawn from the above test results:
addition of the wax leads to increased softening points;
addition of the wax leads to increased viscosities;
addition of the wax leads to decrease penetration depth of the resulting asphalt.

More specifically, the addition of wax increased the viscosities by 1% to 64% when compared to formulations just using GTR. Similarly, the softening point increased by 6.2% to 21.5% when compared to formulations just using GTR.

Increasing the softening point and decreasing the penetration depth of asphalt formulation provides the following benefits:
reducing the time required for asphalt oxidation;
increasing the asphalt resistance to flow at high temperatures;
improving the hardness properties of the asphalt;
allowing for greater control of tailoring the physical properties of the asphalt; and
handling variations in the supply stream.

In some embodiments, the percentage of wax in the asphalt formulation is between and inclusive of 1-3 percent by weight. In some embodiments, the percentage of GTR in the asphalt formulation is between and inclusive of 10-30 percent by weight. In some preferred embodiments the percentage of GTR in the asphalt formulation is between and inclusive of 10-20 percent by weight.

In at least some embodiments, the wax is incorporated into an asphalt flux that can be used in roofing asphalts, paving asphalts, crack fillers, adhesives and/or other products for waterproofing and joint sealing. In at least some embodiments, the wax can be incorporated into oxidized asphalt such as coating-grade asphalt and mopping-grade asphalt. In other embodiments, the wax can be incorporated into non-oxidized asphalt such as saturant-grade asphalt.

Changes to the wax, including but not limited to its molecular weight, and/or polymer backbone structure, can change the properties of the asphalt mixture.

Other potential benefits include increasing the shelf life of an asphalt formulation and extending the lifespan of roofing and coating materials that use a wax-modified asphalt formulation.

In some embodiments, waxes can be used in asphalt binders to increase performance grade. Such modifications can make the asphalt more stable at higher temperatures. Wax-modified asphalt binders can be used in applications such as patching, paving and coating.

In some embodiments, the resulting product can be used in road applications such as, but not limited to, hot mix asphalt, asphalt rubber, rubberized asphalt, and chip seals.

In some embodiments, the addition of the wax improves the performance grade of an asphalt binder alone or in conjunction with other modifiers/additives by increasing the high service temperature. In certain embodiments, the modifiers can be ground tire rubber and various polymers. Increasing the high service temperature of asphalt as well as addition of GTR, can provide at least one, if not all, of the following benefits:
increasing asphalt stability at higher temperatures, making it better suited for use in hot climates;
preventing softening and deformation of pavement due to traffic; and/or lowering manufacturing costs;
increasing road elasticity or recovery under various weather and/or load-related stresses;
lowering the formulation cost compared to use of SBS; and/or
reducing the amount of GTR in landfills.

In some embodiments the wax allows for GTR to be used with or as a replacement of SBS, offsetting it by 1-100 percent, without negatively affecting the asphalt formulation.

In at least some embodiments, the wax is incorporated into asphalt used in paving asphalts, crack fillers, adhesives and other products for waterproofing and joint sealing. In at least some embodiments, the wax can be incorporated into oxidized asphalt such as coating-grade asphalt and mopping-grade asphalt. In other embodiments, the wax can be incorporated into non-oxidized asphalt such as saturant-grade asphalt.

In some preferred embodiments, a polypropylene wax can be used to improve performance grade of paving asphalt binder.

While particular elements, embodiments and applications of the present invention have been shown and described, it will be understood, that the invention is not limited thereto since modifications can be made without departing from the scope of the present disclosure, particularly in light of the foregoing teachings.

What is claimed is:

1. An asphalt formulation comprising:
(a) an amount of a wax;
(b) an amount of a ground tire rubber or an amount of recycled plastic; and
(c) an amount of a base asphalt.

2. The asphalt formulation of claim 1 further comprising:
(d) an amount of an asphalt extender.

3. The asphalt formulation of claim 1 further comprising:
(d) an amount of an asphalt flux.

4. The asphalt formulation of claim 1 further comprising:
(d) an amount of a cross linking agent.

5. The asphalt formulation of claim 1 wherein said wax is made via depolymerization of polypropylene.

6. The asphalt formulation of claim 1 wherein said wax is made via depolymerization of polystyrene.

7. The asphalt formulation of claim 1 wherein said wax is made via depolymerization of polyethylene.

8. The asphalt formulation of claim 1 wherein said wax is made via depolymerization of a polymeric material.

9. The asphalt formulation of claim 8 wherein said polymeric material is at least partially made up of recycled plastics.

10. The asphalt formulation of claim 8 wherein said depolymerization of a polymeric material is a catalytic process.

11. The asphalt formulation of claim 8 wherein said depolymerization of a polymeric material is a thermal process.

12. The asphalt formulation of claim 8 wherein said depolymerization of a polymeric material utilizes free radical initiators.

13. The asphalt formulation of claim 8 wherein said depolymerization of a polymeric material utilizes radiation.

14. The asphalt formulation of claim 1 wherein said amount of said wax is between and inclusive of 0.5 to 20 percent by weight of said asphalt formulation.

15. The asphalt formulation of claim 1 wherein said amount of said ground tire rubber is between and inclusive of 1 to 30 percent by weight of said asphalt formulation.

16. The asphalt formulation of claim 1 wherein said amount of recycled plastics is between and inclusive of 1 to 75 percent by weight of said asphalt formulation.

17. The asphalt formulation of claim 1 wherein said amount of said base asphalt is between and inclusive of 50 to 98.5 percent by weight of said asphalt formulation.

18. The asphalt formulation of claim 1 wherein said wax has a melting point between and inclusive of 100-170° C.

19. The asphalt formulation of claim 1 wherein said wax has a viscosity between and inclusive of 20-10,000 cps.

20. The asphalt formulation of claim 1 wherein said wax has an acid number between inclusive of 0-50 mg KOH/g.
